(19) United States
(12) Patent Application Publication
(10) Pub. No.: US 2015/0332417 A1
(43) Pub. Date: Nov. 19, 2015

(54) PROPERTY NOTIFICATION AND TRIP PLANNING

(71) Applicants: Verizon Patent and Licensing Inc., Arlington, VA (US); Cellco Partnership d/b/a Verizon Wireless, Arlington, VA (US)

(72) Inventors: Thomas W. Haynes, San Ramon, CA (US); Kumar Sanjeev, San Ramon, CA (US); Kent W. Hughes, Oakland, CA (US); Sethumadhav Bendi, Walnut Creek, CA (US); Maria G. Lam, Oakland, CA (US); Thaddeus J. Dudziak, Pleasanton, CA (US); John F. Macias, Antelope, CA (US); Priscilla Lau, Fremont, CA (US); Lalit R. Kotecha, San Ramon, CA (US); David Chiang, Fremont, CA (US); Mingxing S. Li, San Jose, CA (US)

(73) Assignees: Cellco Partnership d/b/a Verizon Wireless, Arlington, VA (US); Verizon Patent and Licensing Inc., Arlington, VA (US)

(21) Appl. No.: 14/280,180

(22) Filed: May 16, 2014

(51) Int. Cl. G06Q 50/16; G06Q 10/10

(52) U.S. Cl. CPC G06Q 50/16; G06Q 10/109

(57) ABSTRACT

A server device may receive information identifying property features relating to for-sale properties; identify a plurality of properties having one or more of the property features; identify particular properties, of the plurality of properties, having the one or more of the property features; receive location information for the particular properties; and generate, based on the location information, a trip plan identifying the particular properties. The trip plan may identify a sequence in which the particular properties should be visited and a route that should be taken when traveling between the particular properties. The server device may store or output the trip plan.

### BACKGROUND

Property listings (e.g., real-estate listings) may be available in electronic databases. Prospective buyers may look up properties based on property features, and may visit properties during visiting hours (e.g., “Open House” hours). Property listings continuously update to include new properties on the market, and remove properties that are no longer on the market.

### BRIEF DESCRIPTION OF THE DRAWINGS

FIGS. 1-3 illustrate an example overview of an implementation described herein;

FIG. 4 illustrates an example environment in which systems and/or methods, described herein, may be implemented;

FIG. 5 illustrates a flowchart of an example process for outputting an alert when a user device is located within an alert proximity of property meeting particular criteria;

FIG. 6 illustrates an example implementation for receiving and outputting property and alert criteria information;

FIG. 7 illustrates a flowchart of an example process for generating a property visiting plan;

FIG. 8 illustrates an example implementation for receiving and outputting trip planning criteria;

FIG. 9 illustrates a flowchart of an example process for generating a property visiting plan; and

FIG. 10 illustrates example components of one or more devices, according to one or more implementations described herein

### DETAILED DESCRIPTION OF THE PREFERRED EMBODIMENTS

The following detailed description refers to the accompanying drawings. The same reference numbers in different drawings may identify the same or similar elements.

Systems and/or methods, as described herein, may provide a technique to alert a user of a user device with regards to property (e.g., for-sale real estate) that is available for visiting (e.g., during “Open House” hours) and when the user device travels to within a particular threshold distance of the property. In some implementations, the systems and/or methods may identify properties meeting particular criteria, and generate a route that a user may use to visit the properties at a desired time and when the properties are available for visiting (e.g., during “Open House” hours).

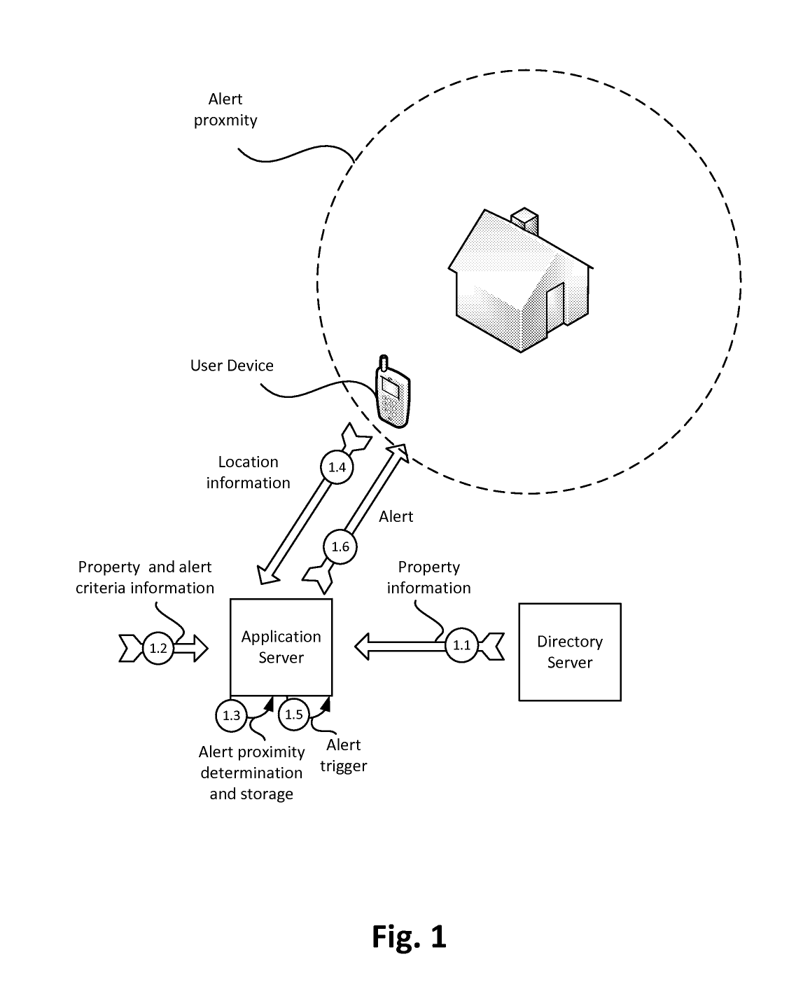

FIGS. 1-3 illustrate an example overview of an implementation described herein. As shown in FIG. 1, an application server may receive property information from a directory server (arrow 1.1). For example, the directory server may store information for properties that are on sale, and may store features of the properties (e.g., sales price, square footage, lot size, number of bedrooms, number of bathrooms, etc.). The directory server may also store location information of the properties (e.g., in addition to information regarding features of the properties), and information regarding “Open House” hours or hours in which the properties are available for visiting (e.g., by prospective buyers).

As further shown in FIG. 1, the application server may receive property and alert criteria information (arrow 1.2). The property and alert criteria information may identify a user, features of properties of which the user should receive alerts (e.g., price, lot size, square footage, number of bedrooms, etc.), and when these alerts should be provided to the user. For example, property and alert criteria information may identify that the user should be alerted about particular property having particular features when the user is located within a particular threshold distance of the particular property, when the particular property is available for visiting, and/or when some other criteria has been met.

Based on receiving the property and alert criteria information, the application server may determine and store alert proximity information (arrow 1.3). An alert proximity may be based on the geographic location of particular property having the particular features, and may have a radius that corresponds to the threshold distance identified in the property and alert criteria information. Based on determining one or more alert proximities (e.g., an alert proximity for each property having the particular features), the application server may store information associating the alert proximities with the user.

In some implementations, a user device, associated with the user, may periodically or intermittently provide location information to the application server (arrow 1.4). The application server may determine that the user device is located within an alert proximity (e.g., within a threshold distance of property having the particular features), and may trigger an alert (arrow 1.5). In some implementations, the application server may trigger the alert when the particular property is available for visiting. The application server may provide an alert (arrow 1.6) to the user device, and the user device may display the alert to inform the user that the particular property is within the threshold distance and that the particular property is available for visiting.

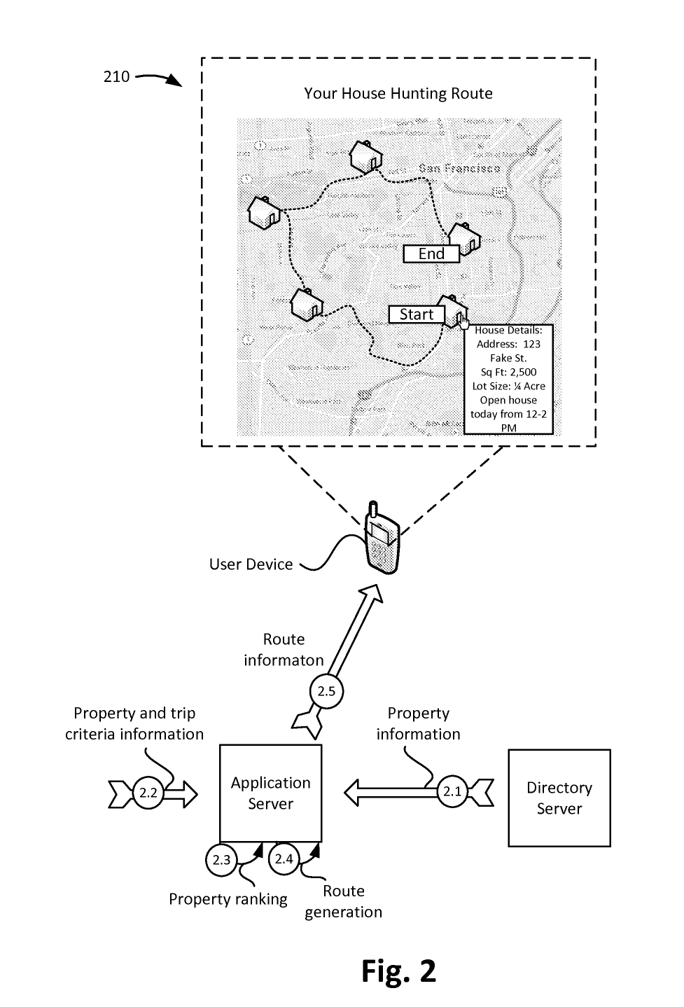

Referring to FIG. 2, the application server may generate a route that identifies properties having particular features and that are available for visiting during a desired time period. For example, the application server may receive property information from the directory server (arrow 2.1), and property and trip criteria information (arrow 2.2). The property and trip criteria information may identify features of properties that should be included in a route, and a desired time period in which a user wishes to visit the properties. Based on the property information received from the directory server, and the property and trip criteria information, the application server may identify properties meeting particular criteria (e.g., having particular features), and that are available for visiting during the time period identified in the property and trip criteria information.

The application server may also rank the properties (arrow 2.3) based on weightings of features identified in the property and trip criteria information. For example, the price feature may be weighed higher than the square footage feature. The application server may then generate a route (arrow 2.4) based on the property rankings, the locations of the identified properties, and/or a routing technique (e.g., a routing technique to minimize drive time, minimize tolls, etc.). In some implementations, the application server may generate the route so that higher ranked properties may be included in the route in favor of lower ranked properties (e.g., if the amount of time in the trip is not sufficient to accommodate visiting all of the identified properties). Based on generating the route, the application server may provide the route information to the user device (arrow 2.5). The user device may display the route information (as shown in interface 210). In some implementations, the user device may receive a selection for a particular property, and may display (e.g., in a “pop-up” window), features and/or details of the property (e.g., property address, square footage, lot size, visiting hours, etc.).

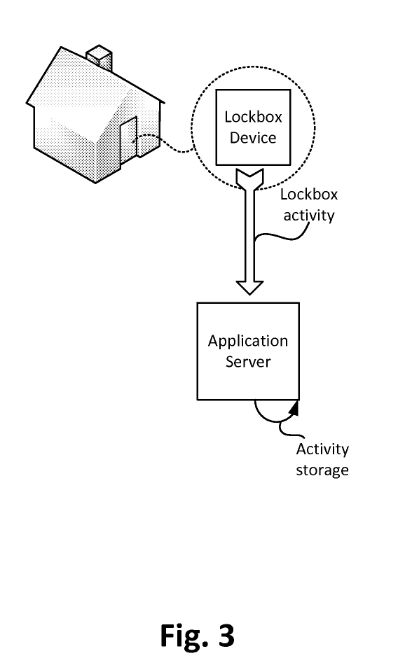

Referring to FIG. 3, the application server may receive lockbox activity information from a lockbox device associated with particular property. For example, the lockbox device may detect the removal and/or usage of a key, used to enter the property, and may provide, to the application server, information identifying the lockbox activity. The application server may store the lockbox activity information. In some implementations, the application server may output the lockbox activity information (e.g., to a property owner) in order to notify the property owner of the presence of visitors and/or unauthorized individuals while the property owner is away. In some implementations, the application server may process the lockbox activity information to generate an activity report that indicates the popularity or interest level of the property.

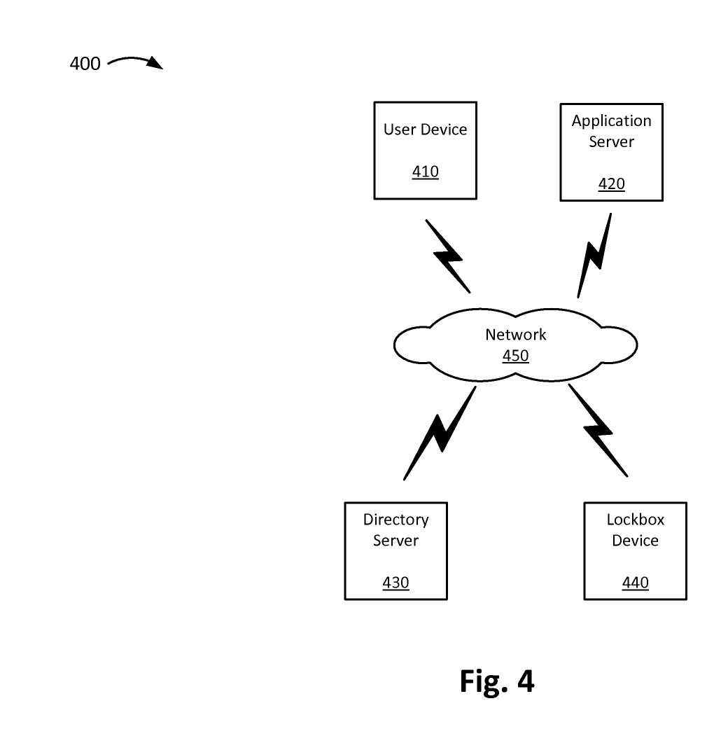

FIG. 4 is a diagram of an example environment 400 in which systems and/or methods described herein may be implemented. As shown in FIG. 4, environment 400 may include user device 410, application server 420, directory server 430, lockbox device 440, and network 450.

User device 410 may include a device capable of communicating via a network, such as network 450. For example, user device 410 may correspond to a mobile communication device (e.g., a smart phone or a personal digital assistant (PDA)), a portable computer device (e.g., a laptop or a tablet computer), a desktop computer device, and/or another type of device. In some implementations, user device 410 may communicate with application server 420 in order to access a user account that stores property and alert criteria information. User device 410 may receive alerts regarding properties available for viewing based on the property and alert criteria information and a current location of user device 410. User device 410 may provide property and trip criteria information to application server 420, and receive corresponding route information.

Application server 420 may include one or more computing devices, such as a server device or a collection of server devices. In some implementations, application server 420 may receive property and trip criteria information from user device 410, and may output an alert to user device 410 based on the property and alert criteria information and a current location of user device 410. Application server 420 may receive property and trip criteria information from user device 410, determine properties meeting criteria and available for visiting during particular hours, and determine a route that may be used to visit the determined properties. Application server 420 may output the route information to user device 410. Application server 420 may receive lockbox activity information from lockbox device 440 associated with particular property. Application server 420 may store and/or output the lockbox activity information.

Directory server 430 may include one or more computing devices, such as a server device or a collection of server devices. In some implementations, directory server 430 may store property listings for properties that are available for sale. For a particular listing for particular property, directory server 430 may store features of the particular property, such as sales price, sales history, lot size, number of bathrooms, number of bedrooms, square footage, school rankings, and/or some other feature associated with the particular property. Directory server 430 may also store location information associated with property listings (e.g., in addition to information regarding features of the properties). Directory server 430 may store information identifying visiting hours for the particular property.

Lockbox device 440 may include a device that may provide access to a particular property. For example, lockbox device 440 may store a physical key that may be accessed to access the particular property. Additionally, or alternatively, lockbox device 440 may include a keypad that may be used to receive a code that may provide access to the physical key or to the property without the physical key. Lockbox device 440 may store lockbox activity information that identifies when the physical key has been removed, and/or when a code has been entered to access the property. For example, the physical key may transmit a transponder signal, and lockbox device 440 may determine that the key has been removed when the transponder signal is not received by lockbox device 440. Lockbox device 440 may communicate with user device 410 and/or application server 420 via network 450 to output lockbox activity information.

Network 450 may include one or more wired and/or wireless networks. For example, network 450 may include a cellular network (e.g., a second generation (4G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, network 450 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in environment is not limited to what is shown in FIG. 4. In practice, environment 400 may include additional devices and/or networks; fewer devices and/or networks; different devices and/or networks; or differently arranged devices and/or networks than illustrated in FIG. 4. Also, in some implementations, one or more of the devices of environment 400 may perform one or more functions described as being performed by another one or more of the devices of environment 400. Devices of environment 400 may interconnect via wired connections, wireless connections, or a combination of wired and wireless connections.

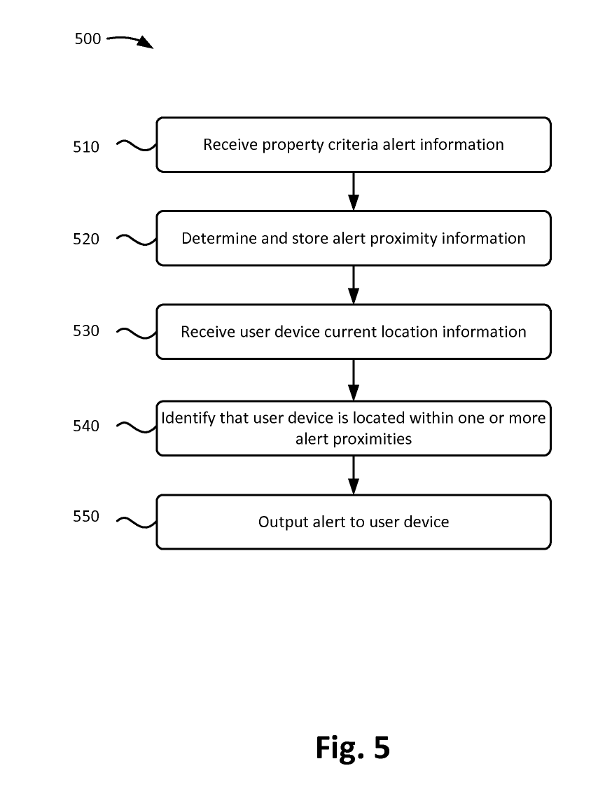

FIG. 5 illustrates a flowchart of an example process 500 for outputting an alert when a user device is located within an alert proximity of property meeting particular criteria. In some implementations, process 500 may be performed by application server 420. In some implementations, some or all of blocks of process 500 may be performed by one or more other devices.

As shown in FIG. 5, process 500 may include receiving property criteria alert information (block 510). For example, application server 420 may receive property criteria alert information from user device 410. The property and alert criteria information may identify a user of user device 410, features of properties of which the user should receive alerts (e.g., price, lot size, square footage, number of bedrooms, etc.). The property and alert criteria information may also identify locations of properties for which the user should receive alerts. The property and alert information may further identify a threshold distance in which the user should be alerted of particular property having particular features when the user is located within the threshold distance of the particular property. In some implementations, the user of user device 410 may provide the property criteria alert information via an application running on user device 410. For example, the user may select property features, property locations, and a threshold distance value. When selecting the threshold distance value, the user may select, a driving distance, a quantity of driving minutes, and/or some other information regarding a distance from property meeting the criteria.

Process 500 may also include determining and storing alert proximity information (block 520). A particular alert proximity may encompass particular property having the criteria specified by the user of user device 410 as described above in process block 510. The particular alert proximity may include a radius corresponding to the threshold distance identified in the property alert criteria information. Application server 420 may determine alert proximities based on the property criteria alert information. Application server 420 may determine an alert proximity for each property having the specified features, and may store information for each determined alert proximity. For example, application server 420 may communicate with directory server 430 to determine properties having the specified features, and may then store information indicating that user device 410 should be alerted when user device 410 is within a threshold distance (e.g., a distance corresponding to the alert proximity) of the determined properties.

Process 500 may further include receiving user device current location information (block 530). For example, application server 420 may receive information identifying a current location of user device 410 via a location identification device associated with user device 410 (e.g., a global positioning system (GPS) device, or the like). Additionally, or alternatively, application server 420 may receive the current location information of user device 210 from another source, such as from a wireless network. In some implementations, user device 410 and/or other source may periodically or intermittently provide current location information to user device 410.

Process 500 may also include identifying that the user device is located within one or more alert proximities (block 540). For example, application server 420 may determine that user device 410 is located within one or more alert proximities based on the current location information of user device 410 and the alert proximity information determined in process block 520.

Process 500 may further include outputting an alert to the user device (block 550). For example, application server 420 may output the alert to user device 410 based on identifying that user device 410 is located within the one or more alert proximities. In some implementations, the alert may identify a property associated with an alert proximity within which user device 410 is located. The alert may also identify features of the property, and may also include an option for the user to receive directions to the property. In some implementations, the alert may be provided when the property is currently available for viewing (e.g., based on an open house schedule stored by directory server 430).

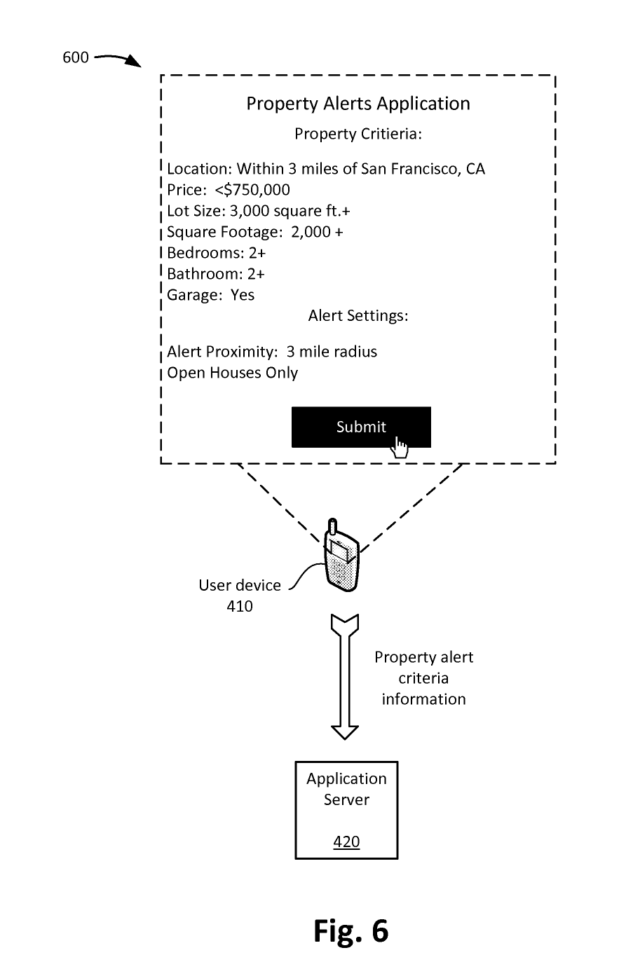

FIG. 6 illustrates an example implementation for receiving and outputting property and alert criteria information. As shown in interface 600 of FIG. 6, a user of user device 410 may select criteria for receiving property alerts. For example, the user may select to receive alerts for property having particular criteria, and when user device 410 is located within a threshold distance from these properties (e.g., an alert proximity). In the example shown in FIG. 6, the user may select to receive alerts for properties within 3 miles of San Francisco, Calif. and having particular features (e.g., a sales price under $750,000, a lot size of a 3,000 square feet or larger, a square footage of 2,000 or larger, 2 or more bedrooms, 2 or more bathrooms, and a garage). The user may select to receive alerts for properties having these features when the user is located within 3 miles of a property having these features, and when the property is open for visiting hours.

Based on receiving the property and alert criteria information, user device 410 may output the property and alert criteria information to application server 420. Application server 420 may then communicate with directory server 430 to identify properties having the specified features, and may store information identifying an alert proximity for each identified property. As described above, application server 420 may provide an alert to user device 410 when user device 410 is located within an alert proximity.

While a particular example is shown in FIG. 6, the above description is merely an example implementation. In practice, other examples are possible from what is described above in FIG. 6. Also, while a particular format of interface 600 is shown, in practice, interface 600 may have a different format and appearance than what is shown in FIG. 6.

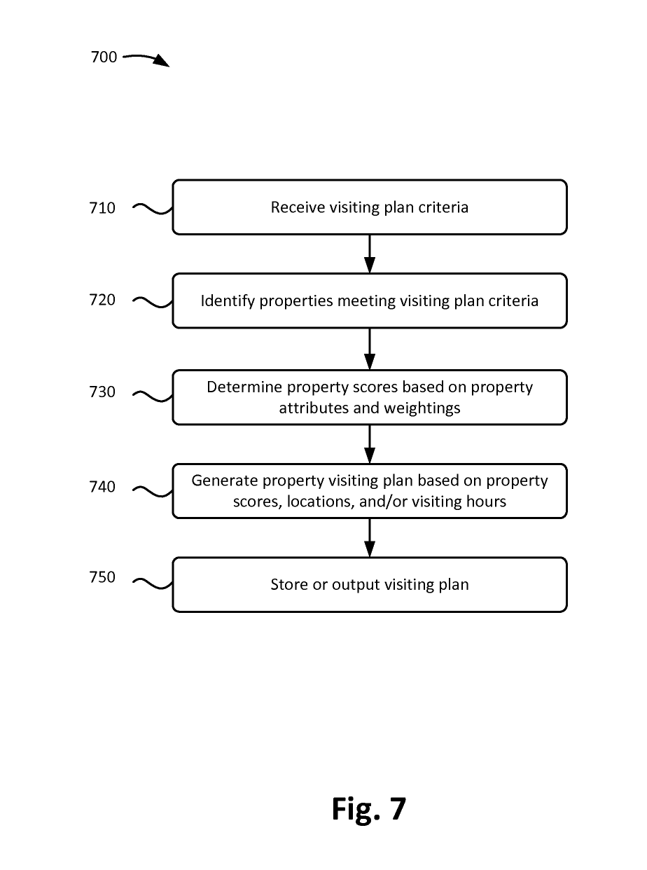

FIG. 7 illustrates a flowchart of an example process 700 for generating a property visiting plan. In some implementations, process 700 may be performed by application server 420. In some implementations, some or all of blocks of process 700 may be performed by one or more other devices.

As shown in FIG. 7, process 700 may include receiving visiting plan criteria (block 710). For example, application server 420 may receive the visiting plan criteria from user device 410. In some implementations, a user of user device 410 may provide the visiting plan criteria via an application running on user device 410. The visiting plan criteria may identify features of properties that the user may be interested in visiting, (e.g., features of properties that may be included in a property visiting plan). The visiting plan may also identify locations of properties that the user may be interested in visiting. In some implementations, the features may be weighted based on importance as indicated by the user. For example, the user may indicate that a first feature (e.g., price) is more important than a second feature (e.g., lot size). Thus, the first feature may be weighed higher than the second feature. For example, the features may be weighted on a sliding scale (e.g., a scale from 0-100, or some other scale). As an example, price may be weighted with a value of 90, whereas lot size may be weighted with a value of 70. The visiting plan criteria may also include a time period in which the properties are to be visited. The visiting plan criteria may also include an indication to include only those properties that are available for visiting in the visiting plan. In some implementations, the visiting plan criteria may also identify an amount of time to allow for each property visit.

Process 700 may further include identifying properties meeting the visiting plan criteria (block 720). For example, application server 420 may communicate with directory server 430 to identify properties that include one or more of the features. In some implementations, application server 420 may communicate with directory server 430 to identify properties that are available for viewing during the time period.

Process 700 may also include determining property scores based on property features and weightings (block 730). For example, application server 420 may determine property scores for each of the identified properties. For a particular property, application server 420 may determine a property score by multiplying each feature of the particular property by the weighting to determine a weighted feature score, and summing the weighted feature scores. For example, assume that the a first feature (e.g., location) is weighted as 10 on a scale of 1 to 10, a second feature (e.g., price) is weighted at 8, and a third feature (e.g., lot size) is weighted as a 5. Further, assume that a first property has the first feature and the second feature, but not the third feature. Given this assumption, the first property may have a property score of 18 (e.g., 10+8). Further, assume that a second property has the second feature and the third feature, but not the first feature. Given this assumption, the second feature may have the property score of 13 (e.g., 8+5). Thus, the first property may be ranked higher than the second property.

Process 700 may further include generating a visiting plan based on the property scores, property locations, and/or visiting hours (block 740). For example, application server 240 may generate the visiting plan. The visiting plan may identify a list of properties that include one or more of the features identified in the visiting plan criteria, and an order in which the properties should be visited. In some implementations, the properties that meet one or more of the features, may not all be included in the visiting plan if the amount of time, identified in the visiting plan criteria, is insufficient to accommodate a visit to each property. The visiting plan may prioritize those properties having the relatively highest scores. The order in which the properties should be visited may be based on the property locations, the property scores, the visiting hours, and/or some other information regarding the priority of the properties. For example, properties located relatively closely to each other may be listed sequentially. Also, properties whose visiting hours end relatively sooner than others may be listed ahead of those properties whose visiting hours end relatively later. In some implementations, properties having higher property scores may be listed sooner than properties having lower property scores. The visiting plan may include a map that includes routing and/or navigation information that may be used by the user to travel from one property to another.

Process 700 may also include storing or outputting the visiting plan (block 750). For example, application server 420 may output the visiting plan to user device 410, and user device 410 may display the visiting plan (e.g., as a table that identifies the properties in the visiting plan and a sequence in which the properties should be visiting). Additionally, or alternatively, the visiting plan may be displayed within a map that identifies the properties and a route to be used to travel from one property to another. An example of visiting plan with a visiting route is shown in FIG. 2.

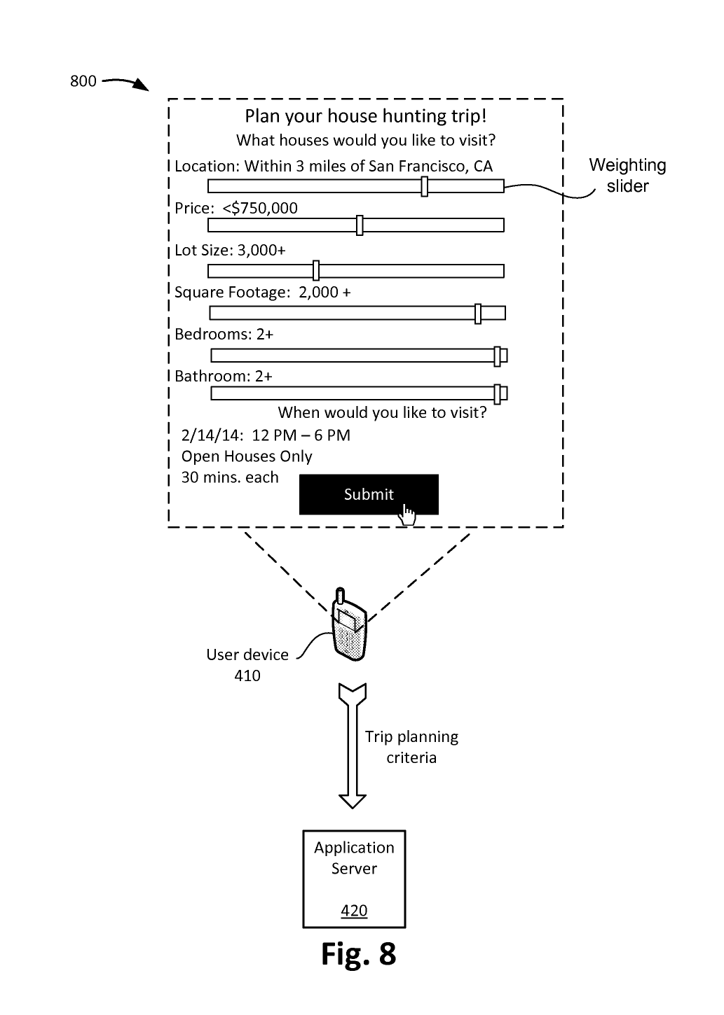

FIG. 8 illustrates an example implementation for receiving and outputting trip planning criteria. As shown in interface 800, user device 410 may receive property features of properties that should be included in a trip plan. User device 410 may also receive weighting information for each feature (e.g., via a slider). User device 410 may also receive a time period for the trip plan, a selection to include “Open Houses,” in the trip plan (e.g., properties available for visiting during the time period), and a duration of the visit for each property. User device 410 may provide the trip planning criteria (e.g., including the property features, weightings, time period, visit duration, and “Open House” selection), to application server 420. Application server 420 may generate a trip plan based on the trip planning criteria as described above.

While a particular example is shown in FIG. 8, the above description is merely an example implementation. In practice, other examples are possible from what is described above in FIG. 8. Also, while a particular format of interface 800 is shown, in practice, interface 800 may have a different format and appearance than what is shown in FIG. 8.

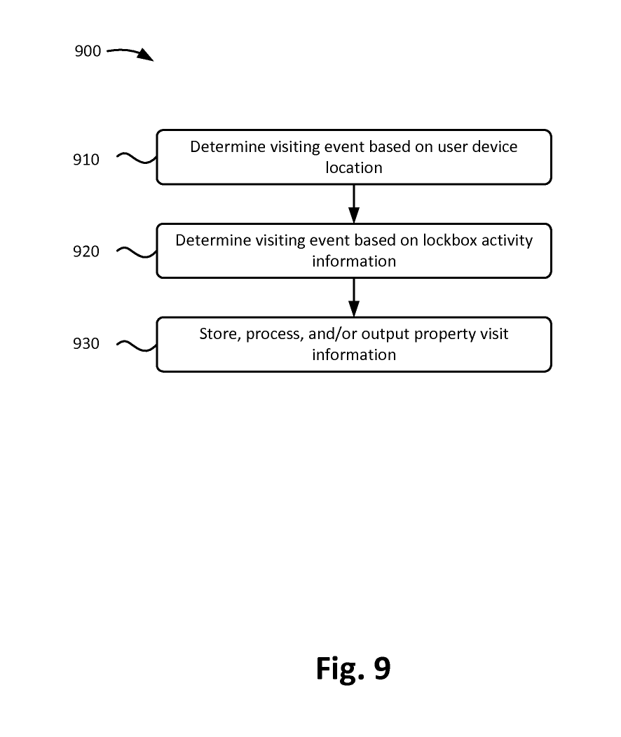

FIG. 9 illustrates a flowchart of an example process 900 for generating a property visiting plan. In some implementations, process 900 may be performed by application server 420. In some implementations, some or all of blocks of process 900 may be performed by one or more other devices.

As shown in FIG. 9, process 900 may include determining a visiting event based on user device location (block 910). For example, application server 420 may determine a visiting event (e.g., when particular property has been visited) based on a location of user device 410. As an example, application server 420 may determine that the particular property has been visited when user device 410 has traveled to the location of the particular property and when user device 410 is located at the particular property for a threshold period of time. In some implementations, application server 420 may determine that the particular property has been visited after application server 420 provides an alert to user device 410 (e.g., when user device 410 is located within an alert proximity associated with the particular property) and when user device 410 travels to the particular property after receiving the alert.

Process 900 may also include determining a visiting event based on lockbox activity information (block 920). For example, application server 420 may receive lockbox activity information from directory server 430, and determine the visiting event when directory server 430 has been accessed (e.g., when a physical key has been removed and/or when directory server 430 has received an unlock code). In some implementations, application server 420 may provide an unlock code to directory server 430 based on authorization information received from user device 410. Additionally, or alternatively, directory server 430 may receive an unlock code via a keypad or from user device 410 (e.g., via a Wi-Fi connection, a short range personal area network (PAN), a wired connection, a near-field communications (NFC) connection, a Bluetooth connection, and/or via some other connection). In some implementations, directory server 430 may determine that a physical key has been removed based on a determining that a transponder signal, transmitted by the physical key, has changed, and/or that the signal strength has dropped below a particular threshold.

Process 900 may further include storing, processing, and/or outputting the property visit information (block 930). For example, application server 420 may store the property visit information, and may output the property visit information to a property owner or other party associated with the particular property. In some implementations, application server 420 may process the property visit information to generate a report that indicates the popularity of the particular property at different times of the day, and the popularity in comparison with other properties.

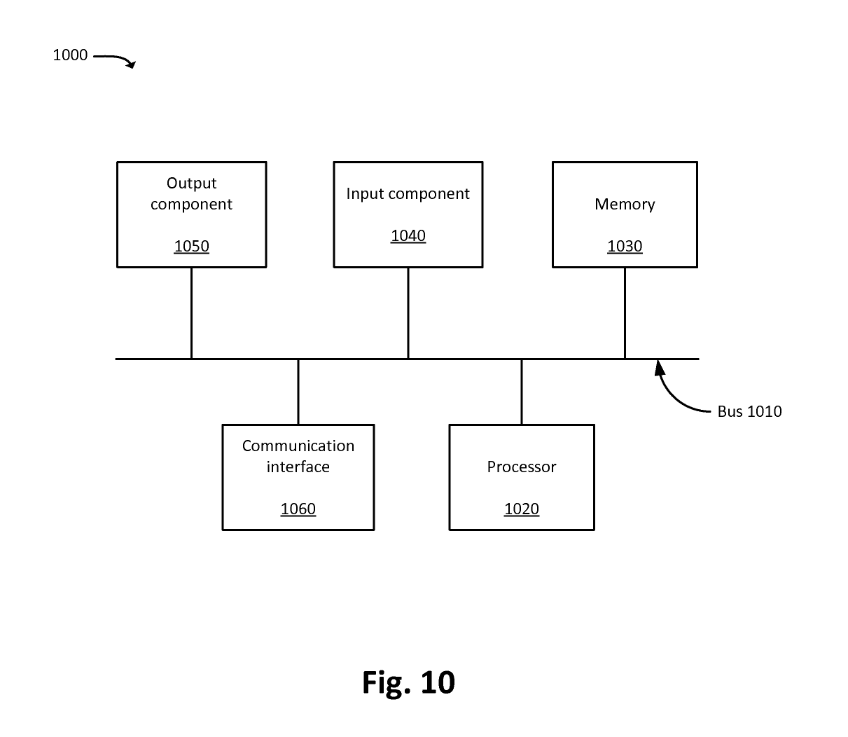

FIG. 10 is a diagram of example components of device 1000. One or more of the devices described above (e.g., with respect to FIGS. 1-4, 6, and 8) may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000, such as a keyboard, a keypad, a button, a switch, etc. Output component 1050 may include a mechanism that outputs information to the operator, such as a display, a speaker, one or more light emitting diodes (LEDs), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations. For example, while series of blocks have been described with regard to FIGS. 5, 7, and 9, the order of the blocks may be modified in other implementations. Further, non-dependent blocks may be performed in parallel.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown (e.g., in FIGS. 1-4, 6, and 8), in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

Some implementations are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “satisfying” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method comprising:
receiving, by a server device, information identifying property features relating to for-sale properties;
identifying, by the server device, a plurality of properties having one or more of the property features;
identifying, the server device, particular properties, of the plurality of properties, having the one or more of the property features;
receiving, by the server device, location information for the particular properties;
generating, by the server device and based on the location information, a trip plan identifying the particular properties,
the trip plan identifying a sequence in which the particular properties should be visited and a route that should be taken when traveling between the particular properties; and
storing or outputting, by the server device, the trip plan.

2. The method of claim 1, further comprising:
generating a score for each of the plurality of properties based on whether features of the properties match the one or more property features,
wherein the particular properties are identified based on the scores.

3. The method of claim 1, wherein the particular properties are identified based on respective visiting hours of the particular properties.

4. The method of claim 1, wherein storing or outputting the trip plan includes outputting the trip plan to cause a user device to present the trip plan in a map displaying the particular properties.

5. The method of claim 1, wherein the sequence in which the particular properties should be visited is based on respective locations of the particular properties, respective visiting hours of the particular properties, or priority information associated with the particular properties.

6. The method of claim 1, further comprising:
receiving location information regarding a user device;
identifying that the user device is located within a threshold distance of at least one of the plurality of properties; and
outputting an alert to the user device indicating that the user device is located within the threshold distance of the at least one of the plurality of properties.

7. The method of claim 6, wherein the threshold distance is based on information regarding at least one of:
a driving time, or
a driving distance.

8. The method of claim 1, further comprising:
determining a visiting event for one of the plurality of properties based on user device location information or based on lockbox activity information received from a lockbox device associated with the one of the plurality of properties; and
storing or outputting information regarding the visiting event.

9. A system comprising:
a server device, comprising:
a non-transitory memory device storing:
a plurality of processor-executable instructions; and
a processor configured to execute the processor-executable instructions, wherein executing the processor-executable instructions causes the processor to:
receive information identifying property features relating to for-sale properties;
identify a plurality of properties having one or more of the property features;
identify particular properties, of the plurality of properties, having the one or more of the property features;
receive location information for the particular properties;
generate, based on the location information, a trip plan identifying the particular properties,
the trip plan identifying a sequence in which the particular properties should be visited and a route that should be taken when traveling between the particular properties; and
store or output the trip plan.

10. The system of claim 9, wherein executing the processor-executable instructions further causes the processor to:
generate a score for each of the plurality of properties based on whether features of the properties match the one or more property features,
wherein executing the processor-executable instructions, to identify the particular properties, causes the processor to identify the particular properties based on the scores.

11. The system of claim 9, wherein executing the processor-executable instructions, to identify the particular properties, causes the processor to identify the particular properties based on respective visiting hours of the particular properties.

12. The system of claim 9, wherein executing the processor-executable instructions, to store or output the trip plan, causes the processor to output the trip plan to cause a user device to present the trip plan in a map displaying the particular properties.

13. The system of claim 9, wherein the sequence in which the particular properties should be visited is based on respective locations of the particular properties, respective visiting hours of the particular properties, or priority information associated with the particular properties.

14. The system of claim 9, wherein executing the processor-executable instructions further causes the processor to:
receive location information regarding a user device;
identify that the user device is located within a threshold distance of at least one of the plurality of properties; and
output an alert to the user device indicating that the user device is located within the threshold distance of the at least one of the plurality of properties.

15. The system of claim 14, wherein the threshold distance is based on information regarding at least one of:
a driving time, or
a driving distance.

16. The system of claim 9, wherein executing the processor-executable instructions further causes the processor to:
determine a visiting event for one of the plurality of properties based on user device location information or based on lockbox activity information received from a lockbox device associated with the one of the plurality of properties; and
store or output information regarding the visiting event.

17. A method comprising:
receiving, by a server device, information identifying features related to for-sale properties;
identifying, by the server device, a plurality of for-sale properties having one or more of the identified features;
receiving, by the server device, location information regarding a user device;
identifying, by the server device, that the user device is located within a threshold distance of at least one of the plurality of for-sale properties; and
outputting an alert to the user device indicating that the user device is located within the threshold distance of the at least one of the plurality of for-sale properties.

18. The method of claim 17, wherein the threshold distance is based on information regarding at least one of:
a driving time, or
a driving distance.

19. The method of claim 17, further comprising:
determining a visiting event for one of the plurality of for-sale properties when the user device is located within the threshold distance of the one of the plurality of for-sale properties for a threshold period of time; and
storing or outputting information regarding the visiting event.

20. The method of claim 17, wherein outputting the alert includes outputting the alert when the one of the at least one of the plurality of properties is available for visiting.
